(19) United States
(12) Patent Application Publication
(10) Pub. No.: US 2026/0095549 A1
(43) Pub. Date: Apr. 2, 2026

(54) ENHANCED INTEGRATION WITH CAMERAS FOR VIRTUAL MEETINGS

(71) Applicant: Google LLC, Mountain View, CA (US)

(72) Inventors: Daniel Enrique Ferrara, New York, NY (US); Jonathan Deokule, Dix Hills, NY (US); Adam Mitchell Merber, Goldens Bridge, NY (US)

(21) Appl. No.: 18/904,496

(22) Filed: Oct. 2, 2024

(51) Int. Cl. H04N 7/15; G06T 7/11; G06T 7/20; G06V 10/25; H04N 7/14

(52) U.S. Cl. CPC H04N 7/157; G06T 7/11; G06T 7/20; G06V 10/25; H04N 7/147; H04N 7/152; G06V 2201/07

(57) ABSTRACT

A method for enhanced integration with cameras for virtual meetings includes presenting, at a first client device, a virtual meeting user interface (UI) during a virtual meeting between participants associated with one or more client devices. The virtual meeting UI includes one or more regions each corresponding to a video stream provided by a respective client device. The method includes obtaining, at a client application on the first client device, a first video stream via a first data channel between an image capture device and the client application, and metadata via a second data channel between the image capture device and the client application. The method includes causing a visual representation of the first video stream to be modified during the virtual meeting based on the metadata obtained via the second data channel.

### TECHNICAL FIELD

Aspects and implementations of the present disclosure relate to virtual meetings and more specifically to enhanced integration with cameras for virtual meetings.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the virtual meeting platform can provide a user interface that includes multiple regions to present the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method for enhanced integration with cameras for virtual meetings. The method includes presenting, at a first client device of one or more client devices, a virtual meeting user interface (UI) of a virtual meeting during a virtual meeting between one or more participants associated with the one or more client devices. The virtual meeting UI may include one or more regions each corresponding to a video stream provided by a respective client device of the one or more client devices. The method includes obtaining, at a client application on the first client device, a first video stream via a first data channel between an image capture device and the client application, and metadata via a second data channel between the image capture device and the client application. A first region of the one or more regions of the virtual meeting UI displays a visual representation of the first video stream obtained from the first data channel. The method includes causing the visual representation of the first video stream to be modified during the virtual meeting based on the metadata obtained via the second data channel.

Another aspect of the disclosure provides a system for enhanced integration with cameras for virtual meetings. The system includes a memory and processing device coupled with the memory. The processing device is configured to perform operations. The operations include presenting, at a first client device of one or more client devices, a virtual meeting UI of a virtual meeting during a virtual meeting between one or more participants associated with the one or more client devices. The virtual meeting UI may include one or more regions each corresponding to a video stream provided by a respective client device of the one or more client devices. The operations include obtaining, at a client application on the first client device, a first video stream via a first data channel between an image capture device and the client application, and metadata via a second data channel between the image capture device and the client application. A first region of the one or more regions of the virtual meeting UI displays a visual representation of the first video stream obtained from the first data channel. The operations include causing the visual representation of the first video stream to be modified during the virtual meeting based on the metadata obtained via the second data channel.

Another aspect of the disclosure provides a non-transitory computer-readable storage medium that includes instructions that, when executed by a processing device, cause the processing device to perform operations. The operations include presenting, at a first client device of one or more client devices, a virtual meeting UI of a virtual meeting during a virtual meeting between one or more participants associated with the one or more client devices. The virtual meeting UI may include one or more regions each corresponding to a video stream provided by a respective client device of the one or more client devices. The operations include obtaining, at a client application on the first client device, a first video stream via a first data channel between an image capture device and the client application, and metadata via a second data channel between the image capture device and the client application. A first region of the one or more regions of the virtual meeting UI displays a visual representation of the first video stream obtained from the first data channel. The operations include causing the visual representation of the first video stream to be modified during the virtual meeting based on the metadata obtained via the second data channel.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for enhanced integration with cameras for virtual meetings, in accordance with some implementations of the present disclosure.

FIG. 2 depicts a flow diagram of a method for enhanced integration with cameras for virtual meetings, in accordance with some implementations of the present disclosure.

FIG. 3 depicts an example system for enhanced integration with cameras for virtual meetings, in accordance with some implementations of the present disclosure.

FIG. 4 depicts an example virtual meeting user interface (UI), in accordance with some implementations of the present disclosure.

FIG. 5 depicts another example virtual meeting UI, in accordance with some implementations of the present disclosure.

FIG. 6 is a block diagram illustrating an example computer system, in accordance with some implementations of the present disclosure.

### DETAILED DESCRIPTION

Aspects of the present disclosure relate to enhanced integration with cameras for virtual meetings. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting. A participant of a virtual meeting can speak to the other participants of the virtual meeting. Some existing virtual meeting platforms can provide a user interface (UI) to each client device connected to the virtual meeting, where the UI displays visual items corresponding to the video streams shared over the network in a set of regions in the UI.

In a conventional virtual meeting, a camera is connected to a client device using a data channel. The camera provides a video stream to the client device over the data channel. The client device displays a visual representation of the video stream in a virtual meeting UI. However, the camera does not typically provide metadata for the video stream over the data channel (e.g., because the data channel is dedicated to providing the video stream, and providing the metadata would cause the video stream to be delayed). Even if the data channel were to provide some metadata, the metadata would be sparse.

This presents several disadvantages. If the virtual meeting platform were to obtain real time metadata for many or all of the frames of the video stream, the platform could provide additional features to enhance the video stream or the virtual meeting. However, without such real time metadata, such features cannot be implemented or would produce low-quality results.

Implementations of the present disclosure address the above and other deficiencies by causing a second data channel to be established between the camera and the client device. The camera can implement a technical specification indicated by the virtual meeting platform in order to establish the second data channel. The second data channel may comply with a data channel specification (e.g., the Human Interface Device (HID) specification) such that the second data channel appears, to the virtual meeting platform, to be connected to another device. The camera can use the second data channel to send real time metadata for the video stream from the camera to the client device. Real time metadata may include additional information about the video stream as the video stream is being created (e.g., additional information about scenes, objects and/or backgrounds depicted in the video stream as the video stream is being created).

Aspects of the present disclosure provide technical advantages over previous solutions. One technical problem includes the inability of a camera to send real time metadata to a virtual meeting application. Aspects of the present disclosure provide a technical solution by establishing a second data channel between a camera and a virtual meeting application that provides real time metadata to the virtual meeting application. The virtual meeting application can then use the metadata to enhance the features of the virtual meeting application (e.g., enhance presentation of objects in the virtual meeting UI). Thus, aspects of the present disclosure enhance the operations of the virtual meeting platform and improve a virtual meeting participant's experience with the virtual meeting platform.

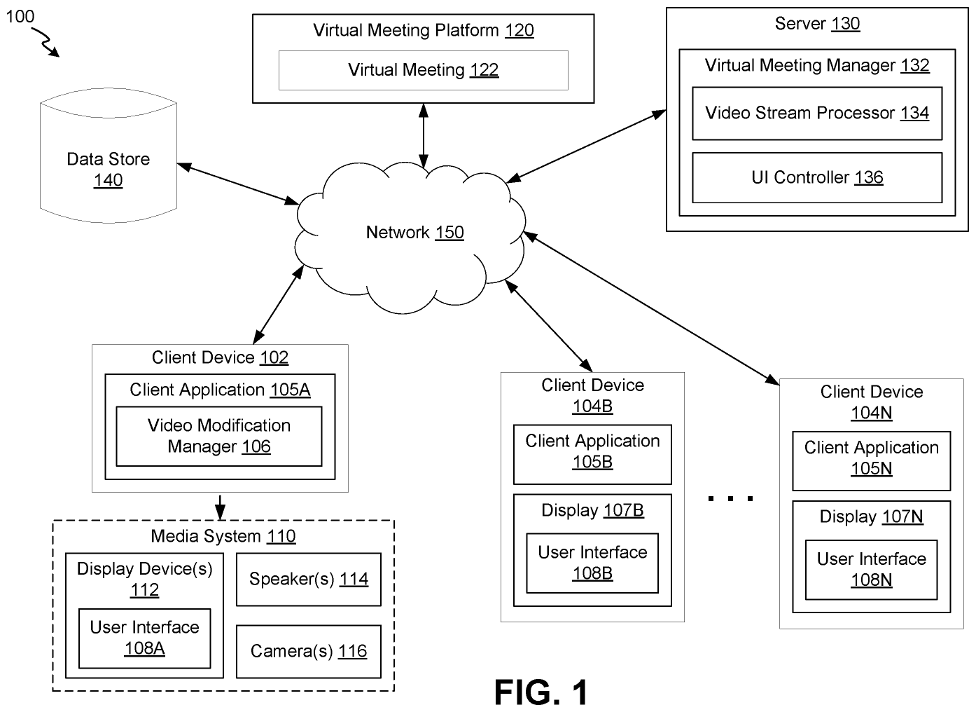

FIG. 1 illustrates an example system architecture 100, in accordance with implementations of the present disclosure. The system architecture 100 includes one or more client devices 102, 104B-N, a virtual meeting platform 120, a server 130, and a data store 140, each connected to a network 150.

In some implementations, the virtual meeting platform 120 enables users of one or more of the client devices 102, 104B-N to connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 may include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120 (such users sometimes being referred to, herein, as “virtual meeting participants” or, simply, “participants”). Implementations of the present disclosure can be implemented with any number of participants connecting via the virtual meeting 122 (e.g., up to one hundred or more).

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the virtual meeting platform 120 or the virtual meeting manager 132 collects user information (e.g., information about a user's social network, social actions or activities, profession, a user's preferences, or a user's current location), or to control whether or how to receive content from the virtual meeting platform 120 or the virtual meeting manager 132 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 132.

In some implementations, the server 130 includes a virtual meeting manager 132. The virtual meeting manager 132, in one or more implementations, is configured to manage a virtual meeting 122 between multiple users of the virtual meeting platform 120. The virtual meeting manager 132 can provide the UIs 108A-N to each client device 102, 104B-N to enable users to watch and listen to each other during a virtual meeting 122. The virtual meeting manager 132 can also collect and provide data associated with the virtual meeting 122 to each participant of the virtual meeting 122. In some implementations, the virtual meeting manager 132 provides the UIs 108A-N for presentation by client applications 105A-N. For example, the respective UIs 108A-N can be displayed on the display devices 107A-107N by the client applications 105A-N executing on the operating systems of the client devices 102, 104B-N. In some implementations, the virtual meeting manager 132 determines visual items for presentation in the UIs 108A-N during a virtual meeting. A visual item can refer to a UI element that occupies a particular region in the UI and is dedicated to presenting a video stream from a respective client device. Such a video stream can depict, for example, a user of the respective client device 102, 104B-N while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 132 includes a video stream processor 134 and a UI controller 136. Each of the video stream processor 134 or the UI controller 136 may include a software application (or a subset thereof) that performs certain virtual meeting functionality for the virtual meeting manager 132. The video stream processor 134 may be configured to receive video streams from one or more of the client devices 102, 104B-N. The video stream processor 134 may be configured to determine visual items for presentation in the UI of such client devices 102, 104B-N (e.g., the UIs 108-108N, discussed below) during the virtual meeting 122. Each visual item can correspond to a video stream from a client device 102, 104B-N (e.g., the video stream pertaining to one or more participants of the virtual meeting 122). In some implementations, the video stream processor 134 receives audio streams associated with the video streams from the client devices (e.g., from an audiovisual component of the client devices 102, 104B-N). Once the video stream processor 134 has determined visual items for presentation in the UI, the video stream processor 134 can notify the UI controller 136 of the determined visual items. The visual items for presentation can be determined based on current speaker, current presenter, order of the participants joining the virtual meeting 122, list of participants (e.g., alphabetical), etc.

In some implementations, the UI controller 136 provides the UI for the virtual meeting 122 (e.g., the UI 108A-N). The UI can include multiple regions. Each region can display a visual item representing a video stream pertaining to one or more participants of the virtual meeting 122. The UI controller 136 can control which video stream is to be used by providing a command to one or more client devices 102, 104B-N that indicates which video stream is to be represented in which region of the UI (along with the received video and audio streams being provided to the client devices 102, 104B-N). For example, in response to being notified of the determined visual items for presentation in the UI 108A-N, the UI controller 136 can transmit a command causing each determined visual item to be displayed in a region of the UI and/or rearranged in the UI.

In some implementations, each of the virtual meeting platform 120 or the server 130 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. The virtual meeting platform 120 can also include a website (e.g., one or more webpages) or application back-end software that can be used to enable a user to connect with other users by way of the virtual meeting 122.

In some implementations, the one or more client devices 104B-N each include one or more computing devices such as personal computers (PCs), laptops, mobile phones, smart phones, tablet computers, netbook computers, network-connected televisions, etc. The one or more client devices 104B-N can also be referred to as “user devices.” Each client device 104B-N can include an audiovisual component that can generate audio and video data to be streamed to the virtual meeting manager 132. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 104B-N. In some implementations, the audiovisual component includes an image capture device (e.g., a camera) to capture images and generate video data (e.g., a video stream) of the captured data of the captured images.

In some implementations, the system architecture 100 includes a client device 102. The client device 102 can differ from a client device of the one or more client devices 104B-N because the client device 102 may be associated with a physical conference or meeting room. Such client device 102 can include or be coupled to a media system 110 that can include one or more display devices 112, one or more speakers 114, and one or more cameras 116. The display device 112 can be, for example, a smart display or a non-smart display (e.g., a display that is not itself configured to connect to the network 150). Participants that are physically present in the room can use the media system 110 rather than their own devices (e.g., one or more of the client devices 104B-N) to participate in the virtual meeting 122, which can include other remote participants. For example, the participants in the room that participate in the virtual meeting 122 can control the display device 112 to show a slide presentation or watch slide presentations of other participants. Sound and/or camera control can similarly be performed. Similar to client devices 104B-N, the client device 102 can generate audio and video data to be streamed to the virtual meeting manager 132 (e.g., using one or more microphones, speakers 114, and cameras 116).

As described previously, an audiovisual component of each client device 102, 104B-N can capture images and generate video data (e.g., a video stream) of the captured data of the captured images. In some implementations, the client devices 102, 104B-N transmit the generated video stream to the virtual meeting manager 132. The audiovisual component of each client device 102, 104B-N can also capture an audio signal representing speech of a user and generate audio data (e.g., an audio file or audio stream) based on the captured audio signal. In some implementations, the client devices 102, 104B-N transmit the generated audio data to the virtual meeting manager 132.

In some implementations, each client device 102, 104B-N includes a respective client application 105A-N, which can be a mobile application, a desktop application, a web browser, etc. The client application 105A-N can present, on a display device 107B-N, 112 of a client device 102, 104B-N or a UI (e.g., a UI of the UIs 108A-N), one or more features of the application 105A-N for users to access the virtual meeting platform 120. For example, a user of the client device 102 can join and participate in the virtual meeting 122 via a virtual meeting UI 108A presented on the display device 112 by the client application 105A. The user can present a document to participants of the virtual meeting 122 using the virtual meeting UI 108A. Each of the UIs 108A-N can include multiple regions to present visual items corresponding to video streams of the client devices 102, 104B-N provided to the server 130 for the virtual meeting 122.

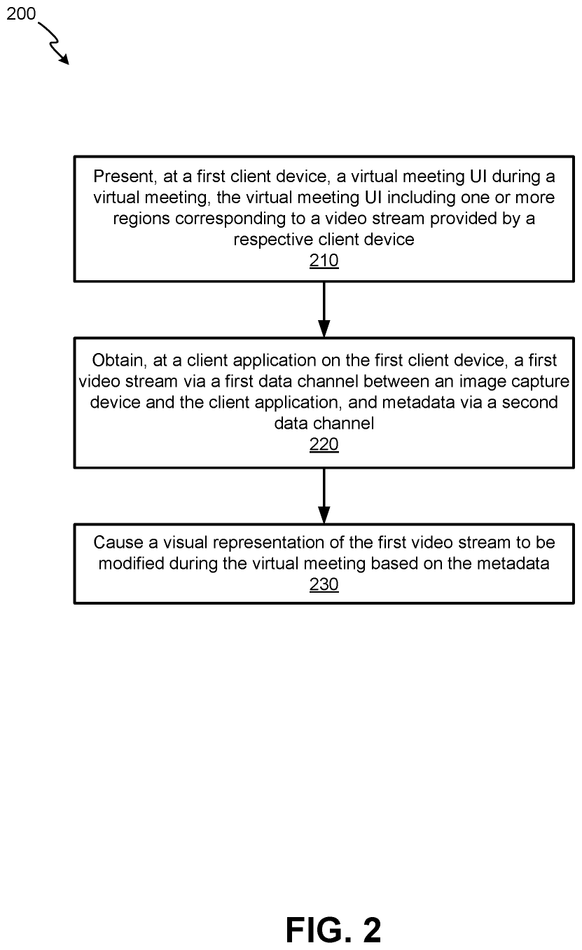

In one or more implementations, the client application 105A includes a video modification manager 106. The video modification manager 106 may include a software application (or a subset of the client application 105A) that performs certain virtual meeting operations for the client application 105A. The video modification manager 106 can be configured and/or otherwise programmed to establish a data channel that provides metadata for a video stream from a camera 116 to the client application 105A, obtain the metadata from the camera 116, and perform one or more operations using the metadata. Some aspects of the video modification manager 106 are discussed further below in relation to FIG. 2. Although FIG. 1 depicts only the client application 105A of the client device 102 including the video modification manager 106, in some implementations, one or more of the client applications 105B-N of the client devices 104B-N include a respective video modification manager 106.

In one or more implementations, the video modification manager 106 is part of a client device 102, 104B-N, as depicted in FIG. 1. In some implementations, at least a portion of the video modification manager 106 is part of the virtual meeting manager 132. For example, the virtual meeting manager 132 may include the video modification manager 106, which can obtain metadata for the video stream produced by a camera 116 of a client device 102, 104A-N. The virtual meeting manager 132 can obtain the video stream from the client device 102 and provide the video stream to the video modification manager 106, which may then use the metadata to modify the video stream.

In some implementations, the client application 105A sends its video stream to the other client devices 102B-N and receives the video streams from the other client devices 102B-N, and the applications 105A-105N can generate their respective virtual meeting UIs 108A-N or can finalize their respective UIs 108A-N, which may have been partially generated by the UI controller 136.

In some implementations, the data store 140 is a persistent storage that is capable of storing data as well as data structures to tag, organize, and index the data. A data item can include audio data and/or video stream data, in accordance with implementations described herein. The data store 140 can be hosted by one or more storage devices, such as main memory, magnetic or optical storage-based disks, tapes, hard drives, flash memory, and so forth. In some implementations, the data store 140 is a network-attached file server, while in other implementations, the data store 140 is some other type of persistent storage such as an object-oriented database, a relational database, and so forth, that can be hosted by the virtual meeting platform 120 or one or more different machines (e.g., the server 130) coupled to the virtual meeting platform 120 using the network 150. In some implementations, the data store 140 stores portions of audio and video streams received from one or more client devices 102, 104B-N for the virtual meeting platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102, 104B-N and/or concurrently editable by the users.

In some implementations, the network 150 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some implementations, the functions of the virtual meeting platform 120 or the server 130 are provided by a fewer number of machines. For example, in some implementations, the server 130 is integrated into a single machine, while in other implementations, the server 130 is integrated into multiple machines. In addition, in one or more implementations, the server 130 is integrated into the virtual meeting platform 120.

In general, one or more functions described in the several implementations as being performed by the virtual meeting platform 120 or server 130 can also be performed by the client devices 102, 104B-N in other implementations, if appropriate. In addition, in some implementations, the functionality attributed to a particular component can be performed by different or multiple components operating together. The virtual meeting platform 120 or the server 130 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

FIG. 2 is a flowchart illustrating one embodiment of a method 200 for enhanced integration with cameras for virtual meetings, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 200 and/or one or more of the method's 200 individual functions, routines, subroutines, or operations. In certain implementations, a single processing thread can perform the method 200. Alternatively, two or more processing threads can perform the method 200, each thread executing one or more individual functions, routines, subroutines, or operations of the method. In an illustrative example, the processing threads implementing the method 200 can be synchronized (e.g., using semaphores, critical sections, and/or other thread synchronization mechanisms). Alternatively, the processing threads implementing the method 200 can be executed asynchronously with respect to each other. Various operations of the method 200 can be performed in a different (e.g., reversed) order compared with the order shown in FIG. 2. Some operations of the method 200 can be performed concurrently with other operations. Some operations can be optional. In some implementations, the video modification manager 106 performs one or more of the operations of the method 200.

At block 210, processing logic presents, at a first client device 102 of one or more client devices 102, 104B-N, a virtual meeting UI 108A during a virtual meeting 122 between one or more participants associated with the one or more client devices 102, 104B-N. The virtual meeting UI 108A may include one or more regions each corresponding to a video stream provided by a respective client device 102, 104B-N of the one or more client devices 102, 104B-N. The client application 105A may cause a display device 112, 107B-N to present the virtual meeting UI 108A-N.

At block 220, processing logic obtains, at a client application 105A on the first client device 102, a first video stream via a first data channel between an image capture device and the client application 105A. Processing logic obtains, at the client application 105A on the first client device 102, metadata via a second data channel between the image capture device and the client application 105A. In one implementation, a first region of the one or more regions of the virtual meeting UI 108A displays a visual representation of the first video stream obtained via the first data channel. In some implementations, the video modification manager 106 obtains the first video stream and the metadata.

A data channel may include a data communication pathway from a first device (e.g., an image capture device) to a second device (e.g., a client device 102, 104B-N). The first device may provide data over the data channel in a standardized data format that is expected by the second device. That is, the first device may transmit data in the expected data format using the data channel. It should be noted that a data channel from the first device to the second device may be between the first device and an application on the second device (e.g., the client application 105A-N).

In one implementation, the first data channel is used to provide video data from the image capture device to the client device 102, 104B-N in a standardized video format expected by the client device 102, 104B-N. The image capture device may transmit the video data over the first data channel using a Universal Serial Bus (USB) cable, a High-Definition Multimedia Interface (HDMI) cable, or some other connection between the image capture device and the client device 102, 104B-N.

In some implementations, the second data channel is used to provide metadata from the image capture device to the client device 102, 104B-N. The second data channel may include a Human Interface Device (HID) side channel. The HID side channel may include a data channel that implements the HID data specification. To the client device 102, 104B-N, the image capture device may appear to be an HID device, such as a mouse, a keyboard, a game controller, or another type of device that implements the HID data specification. In one or more implementations, the second data channel includes a side channel that complies with a different data standard.

In some implementations, the video modification manager 106 establishes the second data channel between the image capture device and the client application 105A-N. The client application 105A-N may implement a specification, and the image capture device may comply with the specification. The specification may indicate how an image capture device can provide data over the second data channel in order to provide the metadata to the client application 105A-N. In one example, a provider of the client application 105A-N may provide the information for the specification (e.g., on a website), and developers of image capture devices may use the information to configure their image capture devices to comply with the specification. In one or more implementations, establishing the second data channel includes the client application 105A-N establishing the second data channel (e.g., the client application 105A-N initiating the establishment of the second data channel) or the client application 105A-N causing the establishment of the second data channel (e.g., the image capture device initiating the establishment of the second data channel).

In one implementation, as discussed above, the first client device 102 is located in a physical conference room. The conference room may host two or more participants of the virtual meeting 122. The image capture device may include a camera 116 of the media system 110 in data communication with the first client device 102.

In some implementations, the metadata identifies a number of participants detected in the video stream transmitted via the first data channel. The image capture device may be configured and/or otherwise programmed to determine a number of people in the view of the image capture device. For example, the image capture device may be configured and/or otherwise programmed to recognize one or more persons in a video frame of a video stream produced by the image capture device, or the image capture device may determine the number of people in the view of the image capture device in other ways.

In one implementation, the metadata includes, for each detected participant in the video stream transmitted via the first data channel, bounding box data corresponding to the respective detected participant. The bounding box data may include a bounding box around at least a portion of the respective participant (e.g., the participant's head, the participant's head and torso, or the like). Bounding box data may include a location of the bounding box (e.g., a location within a video frame of the video stream). The location may be indicated by a coordinate where different locations in the frame of the video stream correspond to specific coordinates. The location may indicate a predetermined portion of the bounding box (e.g., the top left corner). The bounding box data may include dimensional data for the bounding box (e.g., one or more dimensions of one or more portions of the bounding box). The bounding box data may indicate a shape of the bounding box. The bounding box may not necessarily be a rectangle and may be another shape, such as a circle, oval, a polygon, or some other shape.

In some implementations, the metadata includes an order of the detected participants. The order of the detected participants may include, for each detected participant, data indicating in which order the different participants should appear in the virtual meeting UI 108A-N. The order may be based on an order of appearance in the video stream. For example, the order data may indicate that the participant that has been in the video stream the longest is first, the participant that has been in the video stream the second-longest is second, and so on. In another example, the order data may indicate that the participant that has been in the video stream the shortest amount of time is first, and so on. The order may be based on an order of speaking. For example, the order data may indicate that a first participant that is currently speaking (or last spoke) is first, a second participant that spoke before the first participant is second, and so on. The order may be based on other events, actions, or data.

In one implementation, the metadata includes an indication of an active speaker in the video stream transmitted via the first data channel. The indication of the active speaker may include data identifying which participant appearing in the video stream is currently speaking.

In some implementations, the metadata includes data indicating an occurrence of a predetermined event. The predetermined event may include the image capture device detecting an additional participant in the video stream transmitted via the first data channel. For example, a person who was not previously in the video stream may come into view of the image capture device, the video stream may include the additional person, and the metadata may reflect the addition of the person in the video stream. The predetermined event may include the image capture device detecting a participant exiting the video stream transmitted via the first data channel. For example, a person in the video stream may exit the view of the image capture device, the video stream may no longer include the person, and the metadata may reflect the exit of the person. The metadata may indicate an identity of the participant that exited the video stream.

In some implementations, for each frame of the video stream transmitted via the first data channel, the client application 105A may obtain the metadata discussed above. The metadata may pertain to a respective frame of the video stream. The video stream frames or the metadata may include data that the client application 105A can use to determine which portion of the metadata pertains to which frame of the video stream.

At block 230, processing logic causes the visual representation of the first video stream to be modified during the virtual meeting 122 based on the metadata from the second data channel. Causing the visual representation of the first video stream to be modified during the virtual meeting 122 may include causing the visual representation of the video stream to be modified in real time. Real-time modification of the video stream refers to modifying the video stream (e.g., modifying at least some of the data that constitute the video stream) instantly without delays and/or with negligible (e.g., milliseconds or microseconds) delay.

In one implementation, causing the visual representation of the first video stream to be modified includes causing the first region of the one or more regions of the virtual meeting UI 108A-N to be divided into one or more sub-regions. Each sub-region may correspond to a portion of the video stream transmitted via the first data channel.

In some implementations, the video modification manager 106 causes the first region of the virtual meeting UI 108A-N (e.g., the region corresponding to the visual representation of the video stream of the first client device 102) to be divided into multiple sub-regions. Each sub-region can act as a separate region in the virtual meeting UI 108A-N. Each sub-region can display a portion of the visual representation of the video stream of the first client device 102. The different portions of the visual representation of the video stream can present different participants depicted in the video stream. The video modification manager 106 may use the metadata to determine the number of sub-regions to present. The video modification manager may use the metadata to determine which portions of the video stream to present in the respective sub-regions.

In some implementations, the client application 105A of the first client device 102 provides multiple video streams to the virtual meeting manager 132. The multiple video streams may include a video stream for each sub-region of the one or more sub-regions. The virtual meeting manager 132 may cause the video stream processor 134 to provide the video streams to the client applications 105B-N of the one or more other client devices 104B-N for presentation on the UIs 108B-N.

As an example, the video modification manager 106 may obtain a first video frame of the video stream transmitted via the first data channel. The video modification manager 106 may obtain first metadata for the first video frame. The first metadata may indicate that the first video frame includes three participants and may further include data bounding box data indicating the portions of the first video frame where the three participants are located. The video modification manager 106 may cause the first region of the virtual meeting UI 108A-N (which includes the visual representation of the first video stream) to be divided into three sub-regions. Each sub-region may present a respective portion of the visual representation of the first video stream (e.g., a visual representation of the first video frame) where one of the three participants is depicted, as indicated by the metadata for the first video frame. The video modification manager 106 may repeat the above operations with subsequent second, third, fourth, etc. video frames of the first video stream and their respective metadata to continue presenting the three sub-regions that each present a portion of the visual representation of the first video stream that include a respective participant. The sub-regions may be presented in the virtual meeting UI 108A-N.

In some implementations, during a virtual meeting 122, responsive to the metadata indicating that a participant associated with the client device 102 has exited the video stream, the video modification manager 106 may cause the removal of the sub-region corresponding to the exited participant from the one or more sub-regions. The virtual meeting UIs 108A-N may no longer present the removed sub-region. Similarly, during the virtual meeting 122, responsive to the metadata indicating that an additional participant has been detected in the video stream, the video modification manager 106 may cause the addition of a sub-region to the one or more sub-regions that includes the additional participant in the video stream. The virtual meeting UIs 108A-N may present the additional sub-region.

In one implementation, causing the visual representation of the first video stream to be modified includes causing an appearance of a participant included in the video stream transmitted via the first data channel to be enhanced. Enhancing the appearance of the participant may include brightening or enlarging the image of the participant, correcting for low lighting, or other appearance-enhancing operations. Enhancing the appearance of the participant may include enhancing or replacing a background appearing behind or around the participant.

In some implementations, the video modification manager 106 causes an artificial intelligence (AI) model to enhance the appearance of the participant. The video modification manager 106 may provide a video frame (or a portion of a video frame) of the video stream and at least some of the metadata transmitted via the second data channel to the AI model as input, and the AI model may generate a corresponding video frame (or video frame portion) with the appearance of the participant enhanced. The video modification manager 106 may provide the enhanced video frame to the video stream processor 134.

In one implementation, the AI model includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, an AI model includes a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), a large language model (LLM), or a. In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In one implementation, the AI model may include a diffusion model. A diffusion model may include a generative AI model that learns to generate new data by gradually adding noise to an existing dataset and then learns to reverse this process. The forward process, or diffusion, involves iteratively adding noise to the data until it becomes indistinguishable from random noise. The reverse process, or denoising, involves training an ANN to predict the noise added at each step and subtract the noise from the noisy data. By iteratively applying this denoising process, the diffusion model can generate new image data that resemble the original dataset. In some implementations, the diffusion model may use a video frame from the video modification manager 106 as input, and may process a portion of the video frame to enhance the portion of the video frame, and may provide the enhanced video frame as output.

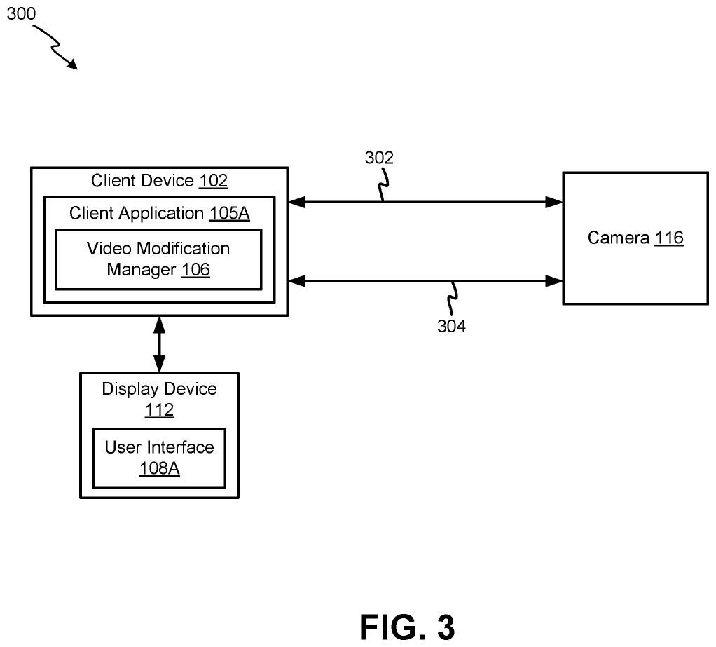

FIG. 3 depicts a system 300 for enhanced integration with cameras for virtual meetings 122, in accordance with some implementations of the present disclosure. The system 300 may include a portion of the system 100 of FIG. 1. For example, the system 300 may include the client device 102, the client application 105A, the video modification manager 106, the display device 112, the virtual meeting UI 108A, and the camera 116.

As seen in FIG. 3, the system 300 may include a first data channel 302. As discussed above, the first data channel 302 may be a data channel used to provide video data from the image capture device (e.g., the camera 116) to the client device 102 in a standardized video format expected by the client device 102. The image capture device may transmit the video data over the first data channel 302 using a USB cable, an HDMI cable, or some other connection between the image capture device and the client device 102.

The system 300 may include a second data channel 304. The second data channel 304 may be a data channel used to provide metadata from the image capture device to the client device 102, 104B-N. The second data channel 304 may include an HID side channel. In some implementations, the video modification manager 106 causes the second data channel 304 to be established.

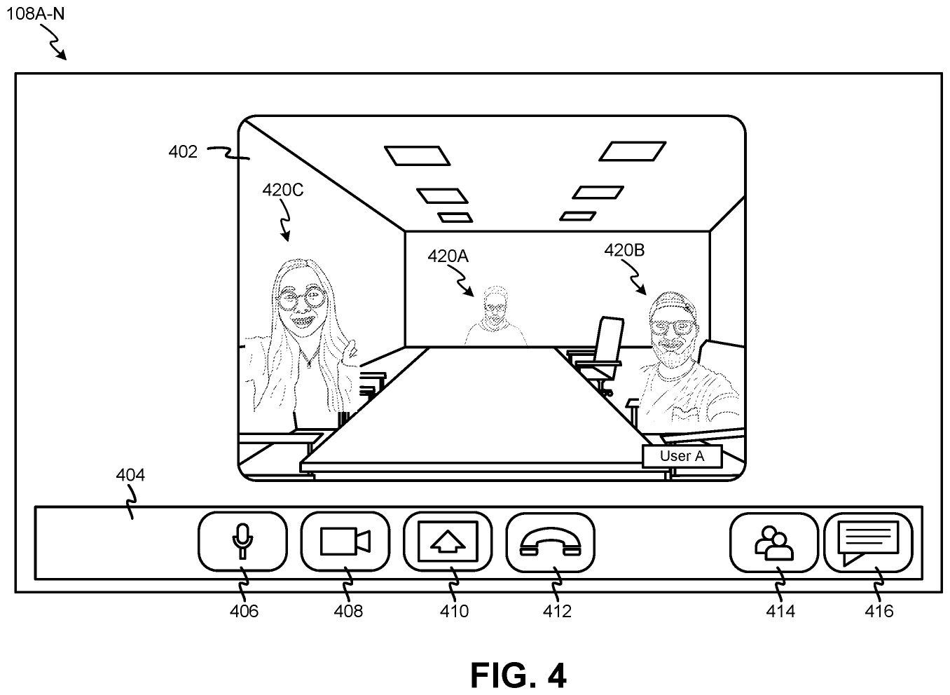

FIG. 4 depicts an example virtual meeting UI 108A-N, in accordance with some implementations of the present disclosure. The UI 108A-N may include a first region 402. As discussed above, the first region 402 may display a visual representation of the first video stream obtained via the first data channel 302.

The virtual meeting UI 108A-N can include a toolbar 404 that includes one or more UI elements that can be used to perform virtual meeting operations. For example, as seen in FIG. 4, the toolbar 404 includes an audio control button 406 used to mute and unmute a participant's audio stream, a camera control button 408 used to mute and unmute a participant's video stream, a screen share button 410 used to share a participant's client device's 102, 104A-N screen with other participants of the virtual meeting 122, and a disconnect button 412 used to leave or disconnect from the virtual meeting 122. The toolbar 404 may include a participants button 414 that can display a list of the one or more participants of the virtual meeting 122. The toolbar 404 may include a chat button 416 that may display a chat interface that allows participants of the virtual meeting 122 to send and receive chat messages in the virtual meeting 122.

In one implementation, the visual representation included in the first region 402 may depict one or more participants 420A-C of the virtual meeting 122. The one or more participants 420A-C may be located in a conference room or meeting room. The one or more participants 420A-C may appear in different locations in the conference or meeting room.

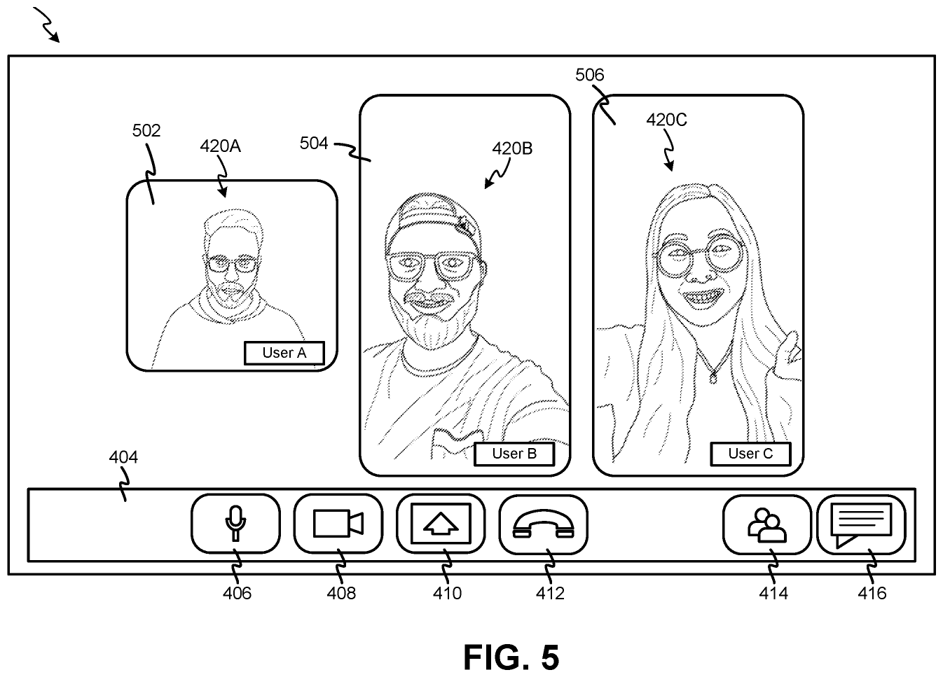

FIG. 5 depicts another example virtual meeting UI 108A-N, in accordance with some implementations of the present disclosure. The UI 108A-N may include one or more components of the UI 108A-N of FIG. 4 (e.g., the toolbar 404 and the UI elements 406-416 included with the toolbar 404). As discussed above, in one implementation, the video modification manager 106 may cause the visual representation of the first video stream to be modified during a virtual meeting 122 based on the metadata transmitted via the second data channel 304. Modifying the visual representation may include dividing the first region 402 into one or more sub-regions 502-506. As can be seen in FIG. 5, the one or more sub-regions 502-506 may include a first sub-region 502. The first sub-region 502 may include a portion of the visual representation of the video stream that includes the first participant 420A. A second sub-region 504 may include a portion of the visual representation of the video stream that includes the second participant 420B. A third sub-region 506 may include a portion of the visual representation of the video stream that includes the third participant 420C.

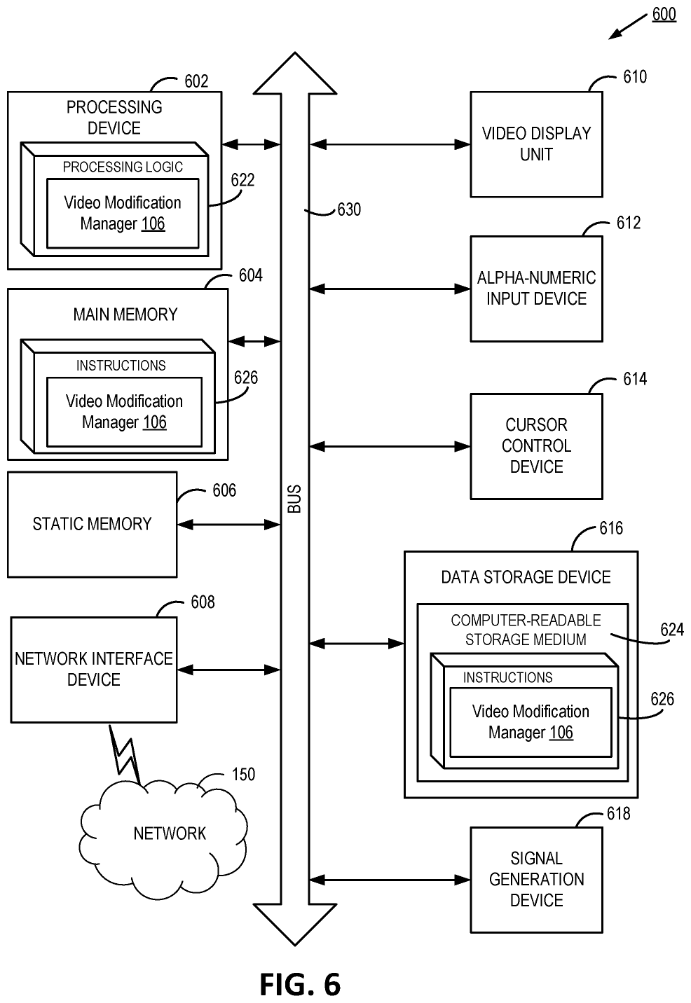

FIG. 6 is a block diagram illustrating an example computer system, in accordance with implementations of the present disclosure. The computer system 600 can include a client device 102, 104B-N, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 616, which communicate with each other via a bus 630.

The processing device 602 represents one or more general-purpose processing devices such as a microprocessor, central processing unit, or the like. More particularly, the processing device 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 can also be one or more special-purpose processing devices such as an application specific integrated circuit (ASIC), a field programmable gate array (FPGA), a digital signal processor (DSP), network processor, or the like. The processing device 602 is configured and/or otherwise programmed to execute the processing logic 622 for performing the operations discussed herein (e.g., the operations of the video modification manager 106).

The computer system 600 can further include a network interface device 608. The computer system 600 also can include a video display unit 610 (e.g., the display device 112, which may include a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 618 (e.g., a speaker).

The data storage device 616 can include a non-transitory machine-readable storage medium 624 (sometimes referred to as a “computer-readable storage medium”) on which is stored one or more sets of instructions 626 (e.g., the instructions to carry out one or more operations of the video modification manager 106) embodying any one or more of the methodologies or functions described herein. The instructions can also reside, completely or at least partially, within the main memory 604 and/or within the processing device 602 during execution thereof by the computer system 600, the main memory 604 and the processing device 602 also constituting machine-readable storage media. The instructions can further be transmitted or received over the network 150 via the network interface device 608.

In one implementation, the instructions 626 include instructions for determining visual items for presentation in a user interface of a virtual meeting. While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method, comprising:
presenting, at a first client device of a plurality of client devices, a virtual meeting user interface (UI) of a virtual meeting during a virtual meeting between a plurality of participants associated with the plurality of client devices, wherein the virtual meeting UI comprises a plurality of regions each corresponding to a video stream provided by a respective client device of the plurality of client devices;
obtaining, at a client application on the first client device:
a first video stream via a first data channel between an image capture device and the client application, and
metadata via a second data channel between the image capture device and the client application, wherein a first region of the plurality of regions of the virtual meeting UI displays a visual representation of the first video stream obtained from the first data channel; and
causing the visual representation of the first video stream to be modified during the virtual meeting based on the metadata obtained via the second data channel.

2. The method of claim 1, wherein causing the visual representation of the first video stream to be modified during the virtual meeting based on the metadata obtained via the second data channel comprises causing the visual representation of the video stream to be modified in real time.

3. The method of claim 1, wherein the second data channel comprises a human interface device (HID) side channel.

4. The method of claim 1, wherein:
the first client device is located in a physical conference room hosting two or more of the plurality of participants; and
the metadata comprises a number of participants of the plurality of participants detected in the video stream obtained via the first data channel.

5. The method of claim 4, wherein the metadata further comprises at least one of:
for each detected participant of the plurality of participants, bounding box data corresponding to the respective detected participant; or
an order of the detected participants of the plurality of participants.

6. The method of claim 1, wherein the metadata comprises an indication of an active speaker in the video stream obtained via the first data channel.

7. The method of claim 1, wherein the metadata comprises data indicating an occurrence of a predetermined event.

8. The method of claim 7, wherein the predetermined event comprises at least one of:
detection of an additional participant of the plurality of participants in the video stream obtained via the first data channel; or
detection of a participant of the plurality of participants exiting the video stream obtained via the first data channel.

9. The method of claim 1, further comprising establishing the second data channel between the image capture device and the client application, wherein the image capture device complies with a specification implemented by the client application.

10. A system, comprising:
a memory; and
a processing device, coupled to the memory, configured to perform operations comprising:
presenting, at a first client device of a plurality of client devices, a virtual meeting user interface (UI) of a virtual meeting during a virtual meeting between a plurality of participants associated with the plurality of client devices, wherein the virtual meeting UI comprises a plurality of regions each corresponding to a video stream provided by a respective client device of the plurality of client devices,
obtaining, at a client application on the first client device:
a first video stream via a first data channel between an image capture device and the client application, and
metadata via a second data channel between the image capture device and the client application, wherein a first region of the plurality of regions of the virtual meeting UI displays a visual representation of the first video stream obtained from the first data channel, and
causing the visual representation of the first video stream to be modified during the virtual meeting based on the metadata obtained via the second data channel.

11. The system of claim 10, wherein:
causing the visual representation of the first video stream to be modified comprises causing the first region to be divided into a plurality of sub-regions; and
each sub-region of the plurality of sub-regions corresponding to a portion of the video stream obtained via the first data channel.

12. The system of claim 10, wherein causing the visual representation of the first video stream to be modified comprises causing an appearance of a participant of the plurality of participants included in the video stream obtained via the first data channel to be enhanced.

13. The system of claim 10, wherein the second data channel comprises a human interface device (HID) side channel.

14. The system of claim 10, wherein:
the first client device is located in a physical conference room hosting two or more of the plurality of participants; and
the metadata comprises a number of participants of the plurality of participants detected in the video stream obtained via the first data channel.

15. The system of claim 14, wherein the metadata further comprises at least one of:
for each detected participant of the plurality of participants, bounding box data corresponding to the respective detected participant; or
an order of the detected participants of the plurality of participants.

16. The system of claim 10, wherein the metadata comprises an indication of an active speaker in the video stream obtained via the first data channel.

17. The system of claim 10, wherein the metadata comprises data indicating an occurrence of a predetermined event.

18. The system of claim 17, wherein the predetermined event comprises at least one of:
detection of an additional participant of the plurality of participants in the video stream obtained via the first data channel; or
detection of a participant of the plurality of participants exiting the video stream obtained via the first data channel.

19. A non-transitory computer-readable storage medium including instructions that, when executed by a processing device, cause the processing device to perform operations comprising:
presenting, at a first client device of a plurality of client devices, a virtual meeting user interface (UI) of a virtual meeting during a virtual meeting between a plurality of participants associated with the plurality of client devices, wherein the virtual meeting UI comprises a plurality of regions each corresponding to a video stream provided by a respective client device of the plurality of client devices;
obtaining, at a client application on the first client device:
a first video stream via a first data channel between an image capture device and the client application, and
metadata via a second data channel between the image capture device and the client application, wherein a first region of the plurality of regions of the virtual meeting UI displays a visual representation of the first video stream obtained from the first data channel; and
causing the visual representation of the first video stream to be modified during the virtual meeting based on the metadata obtained via the second data channel.

20. The computer-readable storage medium of claim 19, wherein:
causing the visual representation of the first video stream to be modified comprises causing the first region to be divided into a plurality of sub-regions; and
each sub-region of the plurality of sub-regions corresponding to a portion of the video stream obtained via the first data channel.
